(19) United States
(12) Patent Application Publication
(10) Pub. No.: US 2013/0257320 A1
(43) Pub. Date: Oct. 3, 2013

(54) METHOD FOR OPERATING AN ELECTRIC TOOL

(71) Applicant: Heiko ROEHM, Stuttgart (DE)

(72) Inventor: Heiko ROEHM, Stuttgart (DE)

(73) Assignee: Robert Bosch GmbH, Stuttgart (DE)

(21) Appl. No.: 13/854,219

(22) Filed: Apr. 1, 2013

(30) Foreign Application Priority Data
Apr. 2, 2012 (DE) 10 2012 205 344.1

(51) Int. Cl. H02P 3/08

(52) U.S. Cl. CPC H02P 3/08
USPC 318/139

(57) ABSTRACT

A method for operating an electric tool and an electric tool, the electric tool having an electric motor and a sensor, the electric tool having a rechargeable energy source for supplying the electric motor and the sensor with power, the sensor being switched to be currentless after the switching off of the electric motor.

### RELATED APPLICATION INFORMATION

The present application claims priority to and the benefit of German patent application no. 10 2012 205 344.1, which was filed in Germany on Apr. 2, 2012, the disclosure of which is incorporated herein by reference.

### FIELD OF THE INVENTION

The present invention relates to a method for operating an electric tool, and to an electric tool.

### BACKGROUND INFORMATION

Various methods are believed to be understood in the related art for operating electric tools having rechargeable energy sources. In certain rechargeable energy sources, such as a lithium ion battery, it is necessary to avoid a deep discharge of the lithium ion battery. For this purpose, an appropriate monitoring electronics system is provided.

### SUMMARY OF THE INVENTION

An object of the exemplary embodiments and/or exemplary methods of the present invention is to provide an improved method for operating an electric tool using a sensor.

The object of the exemplary embodiments and/or exemplary methods of the present invention is attained by the method described herein and by the electric tool described herein.

Further advantageous specific embodiments of the present invention are provided in the further descriptions herein.

According to the exemplary embodiments and/or exemplary methods of the present invention, the sensor, which is supplied with current by the rechargeable energy source, is switched to being currentless after the switching off of the electric motor. In this manner, energy is saved. When the electric motor is activated, the power supply of the sensor is also activated. Consequently, the functionality of the sensor is not impaired while the electric tool is operated. In addition, the power consumption is reduced, and in particular a deep discharge of the rechargeable energy source is avoided.

In one further specific embodiment, the sensor has an evaluation unit, the evaluation unit also being supplied with current. Analogously to the sensor, the evaluation unit is switched to be currentless when the electric motor is not being operated. With that, an additional current consumer is switched to be currentless when it is not being required. Consequently, current is additionally saved and a deep discharge of the energy source is avoided.

In one further specific embodiment, the sensor and/or the evaluation unit are switched to be currentless at a delay in time, after the switching off of the electric motor. In this way, for instance, at briefly consecutive switching on and off of the electric motor, the sensor and the evaluation unit are not unnecessarily switched to be without current. Because of that, even during intermittent operation of the electric motor, the manner of functioning of the sensor and the evaluation unit is not impaired.

In one further specific embodiment, the sensor is configured as an acceleration sensor or a rotation-rate sensor. The acceleration sensor or the rotation-rate sensor offers the possibility of sensing a spontaneous torque increase produced, for example, by the catching of the electric tool, and of achieving the switching off of the electric motor as a protective function.

In a further specific embodiment, the energy source is developed as a battery, particularly as a lithium ion battery. Lithium ion batteries have to be protected from deep discharge. Thus, the method provided is particularly suitable for the protection of lithium ion batteries.

In the following text, the exemplary embodiments and/or exemplary methods of the present invention will be explained in greater detail with reference to the figures.

### BRIEF DESCRIPTION OF THE DRAWINGS

FIG. 1 shows a schematic representation of an electric tool.

FIG. 2 shows a circuit configuration of the electric tool.

FIG. 3 shows a capacitor for the power supply of the sensor and the evaluation unit.

### DETAILED DESCRIPTION

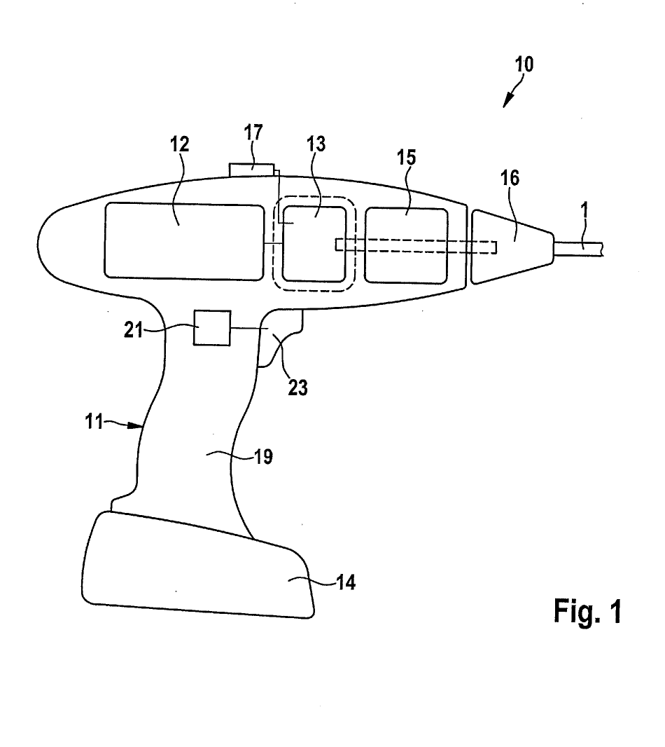

FIG. 1 shows a hand-held electric tool 10. Electric tool 10 may be a screwdriver, a drilling screwdriver, a percussion drill or any other kind of electric tool, in which an electric motor 12 is used to drive or move a tool 1, electric motor 12 being supplied with power by a rechargeable energy source 14. Rechargeable energy source 14 is configured, for instance, as a battery, especially as a lithium ion battery. However, other types of battery may also be used, as a function of the specific embodiment selected. In the exemplary embodiment shown, energy source 14 is connected detachably to a housing 11 of electric tool 10. In the specific embodiment shown, energy source 14 is fastened to the lower end of an handle 19. An operating element 23 is provided on housing 11. Operating element 23 is used for the operation of electric motor 12, i.e. for switching it on and off. In the specific embodiment shown, operating element 23 is developed as a movable key, and is connected to a switch 21. Switch 21 controls the supply of electric motor 12 with power from energy source 14. Electric motor 12 is connected via a gearing 13 and a torque coupling 15 to a tool receptacle 16. Into tool receptacle 16 one is able to insert a tool 1, such as a drill, a chisel, a screwdriver. In addition, a gear shift 17 may be provided, by which a transmission of gearing 13 may be set.

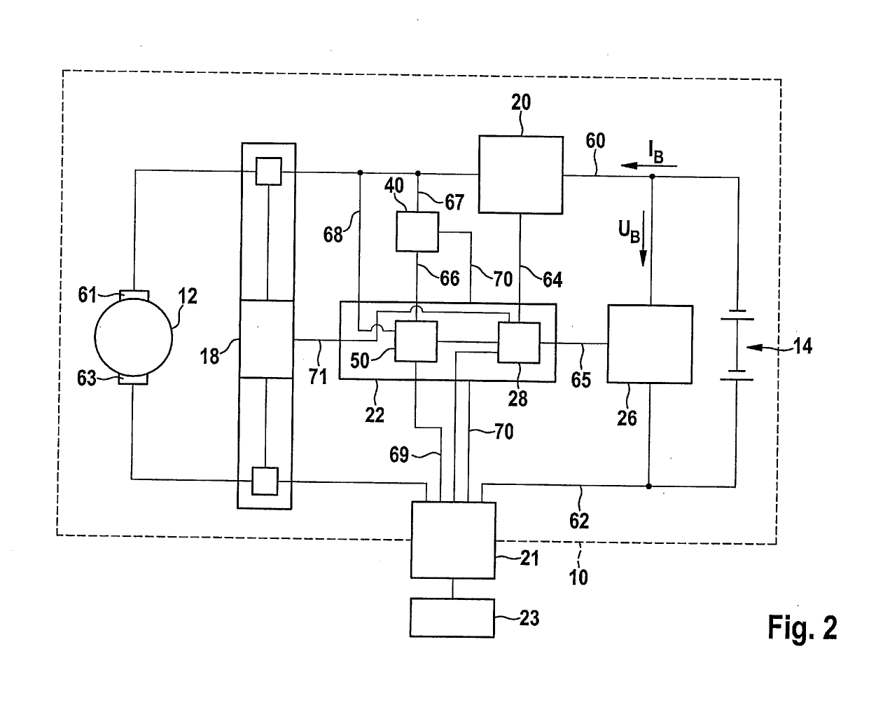

FIG. 2 shows a circuit of electric tool 10. Energy source 14 is connected to a first terminal 61 of electric motor 12 via a first current path 60 via a current measuring device 20 and a control device 18. A second pole of energy source 14 is connected via a second current path 62 via switch 21, control device 18 to a second terminal 63 of electric motor 12. A voltage measuring device 26 is provided parallel to the two poles of energy source 14. Both voltage measuring device 26 and current measuring device 20 are connected to a monitoring unit 22 respectively via sensor lines 64, 65. Monitoring unit 22 has a control unit 28 and an evaluation unit 50. Furthermore, a sensor 40 is provided, which is connected to evaluation unit 50 via a third sensor line 66. Sensor 40 may be developed, for example, as an acceleration sensor or as a rotation-rate sensor, and detect a housing motion and transmit it to evaluation unit 50 of monitoring unit 22. The result of evaluation unit 50 is passed on to control unit 28. For this, evaluation unit 50 may have storage units in the form of registers, for example, in order to store the values recorded by the sensor temporarily. Sensor 40 and evaluation unit 50 are connected to first current path 60 via a first or a second current line 67, 68 respectively. Furthermore, sensor 40 and evaluation unit 50 are connected via a third and fourth current line 69, 70 respectively, via switch 21 to second current path 62. Instead of the power supply described, another type of power supply of the sensor and/or the evaluation unit may also be provided.

Control device 18 is in contact with control unit 28 via a control line 71. Control device 18 is configured so as to pass on the current of first current path 60 to first terminal 61, and to pass on the current from second terminal 63 to switch 21, or to change the direction of the current, i.e. to apply first current path 60 to second terminal 63 of electric motor 12 and to apply second current path 62 to first terminal 61 of electric motor. In addition, the control device is able to carry out a braking of electric motor 12, for instance, by short circuiting the two terminals 61, 63.

The corresponding circuit states of control device 18 are specified by control unit 28. Monitoring unit 20, with the aid of evaluation unit 50 and of sensor 40, ascertains, for example, an exceeding of a specified rotation rate or a specified acceleration of the housing, which represents a spontaneous torque increase of a working case. For this, sensor 40, which has been configured as a rotational rate sensor, for example, or an acceleration sensor, monitors the housing motion and reports it to evaluation unit 50. Evaluation unit 50 compares the sensor signal received and compares it to a boundary value. Evaluation unit 50 transmits an exceeding of the boundary value to control unit 28. If control unit 28 detects the exceeding of the boundary value, control unit 28 controls control device 18 in such a way that the torque of the electric motor is reduced. For this, for example, control device 18 reverses the current direction through motor 12, so that a rotational direction reversal of electric motor 12 takes place. After a motor standstill of electric motor 12 and before revving it up to maximum speed in a changed rotational direction, control unit 28 may switch off the electric motor. Consequently, an initial operation of the electric tool controlled by the operator is ensured. Alternatively, control device 18 induces rapid braking, for instance, by a short circuit operation of electric motor 12 or an adequate method.

Sensor 40 and evaluation unit 50 obtain current from energy source 14. Switch 21 is developed so that, if there is an interruption of the energy supply of electric motor 12 by the release of operating element 23, the energy supply of sensor 40 and/or the energy supply of evaluation unit 50 are also interrupted. This is the case, for example, if the operating person indicates a switching off of the electric motor via a corresponding operation or non-operation of operating key 23.

Furthermore, control unit 28 is connected to switch 21 via a second control line 72. If control unit 28 detects, because of voltage measurement device 26, that the voltage of energy source 14 is falling below a specified lower voltage value, and thus damage is to be expected in the case of a lithium ion battery, switch 21 is actuated by control unit 28 in such a way that switch 21 switches the electric motor and sensor 40 and/or evaluation unit 50 so as to be currentless. In this specific embodiment, too, the power supply of sensor 40 and/or the power supply of evaluation unit 50 are interrupted.

In a further specific embodiment, sensor 40 and/or evaluation unit 50 are switched delayed over time to be currentless after the switching off of electric motor 12. The time delay may amount to, for instance, 15 seconds after the switching off of the electric motor.

As a function of the specific embodiment selected, the power supply of sensor 40 and of evaluation unit 50 may take place via a second energy store 80 which, in turn, is supplied with current from energy source 14 via switch 21. The second energy store may be developed, for example, in the form of a capacitor, and this may ensure the switching off over time of the power supply of sensor 40 and evaluation unit 50.

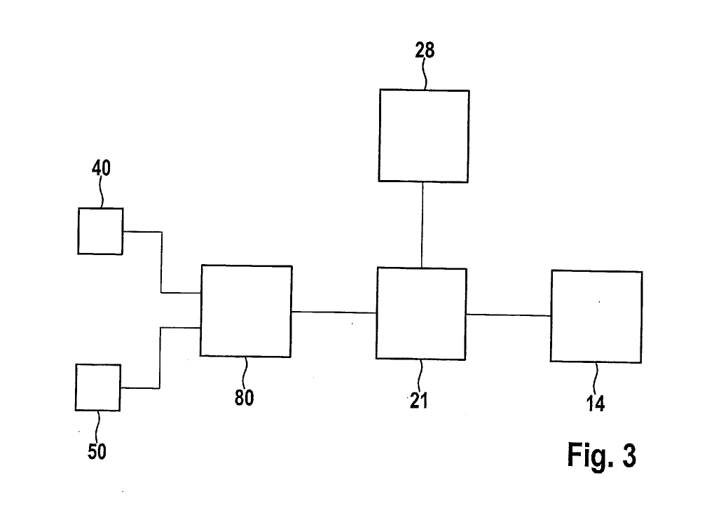

This specific embodiment is shown schematically as a partial section of the circuit of FIG. 2 in FIG. 3.

What is claimed is:

1. A method for operating an electric tool, the method comprising:
switching a sensor of the electric tool, which has an electric motor a rechargeable energy source for supplying the electric motor and the sensor with power, to be currentless after the switching off of the electric motor.

2. The method of claim 1, wherein the electric tool has an evaluation unit for the sensor, and wherein after the switching off of the electric motor, the evaluation unit is switched to be currentless.

3. The method of claim 1, wherein at least one of the sensor and the evaluation unit are switched to be currentless delayed over time, after the switching off of the electric motor.

4. The method of claim 1, wherein the sensor is one of an acceleration sensor and a rotation rate sensor.

5. The method of claim 1, wherein the energy source is a battery.

6. An electric tool, comprising:
an electric motor;
a sensor;
a rechargeable energy source for supplying the electric motor and the sensor with power; and
a device to switch the sensor to be currentless when the electric motor is switched off.

7. The electric tool of claim 6, further comprising:
an evaluation unit for the sensor;
wherein the device is configured to switch the evaluation unit to be currentless after the switching off of the electric motor.

8. The electric tool of claim 6, wherein the device is configured to switch at least one of the sensor and the evaluation unit to be currentless delayed over time, after the switching off of the electric motor.

9. The electric tool of claim 6, wherein the sensor includes one of an acceleration sensor and a rotation rate sensor.

10. The electric tool of claim 6, wherein the energy source is a battery.

11. The electric tool of claim 7, wherein the energy source for at least one of the sensor and the evaluation unit are in the form of a capacitor, which is supplied with power via a switch by the energy source.

12. The electric tool of claim 6, wherein the energy source is a a lithium ion battery.

13. The method of claim 1, wherein the energy source is a lithium ion battery.
